(19) United States
(12) Patent Application Publication
(10) Pub. No.: US 2026/0317073 A1
(43) Pub. Date: Oct. 15, 2026

(54) APPARATUS AND METHOD FOR MONITORING A TRANSPORT PROCESS BY MEANS OF A CONVEYING APPARATUS

(71) Applicant: SICK AG, Waldkirch (DE)

(72) Inventors: Steffen WITTMEIER, Waldkirch (DE); Dominic RUH, Freiburg (DE)

(21) Appl. No.: 19/638,070

(22) Filed: Apr. 2, 2026

(30) Foreign Application Priority Data
Apr. 9, 2025 (EP) 25169314.9

(51) Int. Cl. B65G 43/08; B65G 15/00; G01S 17/58

(52) U.S. Cl. CPC B65G 43/08; B65G 15/00; G01S 17/58; B65G 2203/0233; B65G 2203/025; B65G 2203/044; B65G 2811/095

(57) ABSTRACT

The invention relates to an apparatus for monitoring a transport process by means of a conveying apparatus, in particular a conveyor belt, wherein the apparatus has at least one optoelectronic sensor and a control and evaluation unit, wherein the sensor is configured to transmit transmission light in the form of at least one transmission light beam and to receive transmission light remitted or reflected by an object in the direction of the sensor as reception light, wherein the control and evaluation unit is configured to determine a radial distance d_{rad} and a radial speed v_{rad} of the object on the basis of the reception light, and wherein the control and evaluation unit is configured to determine the orthogonal distance dₒᵣₜₕ between the sensor and the object by means of the radial speed v_{rad} and the radial distance d_{rad} of the object.

The invention relates to an apparatus and a method for monitoring a transport process by means of a conveying apparatus, in particular a conveyor belt.

In the field of logistics and production, the task often arises of measuring the thickness of objects that are transported by means of a conveying apparatus, for example by means of a conveyor belt, as well as their conveying speed. Thus, the speed measurement can be used to measure the length of the conveyed object by a temporal integration. The thickness measurement, on the other hand, can be used for the quality control of the conveyed objects, for example.

Known optical sensors for a high-precision distance measurement of conveyed objects use, for example, interferometric, confocal, triangulation and time-of-flight methods to determine the distance between the sensor and the conveyed object. In this respect, for the time-of-flight measurement, a distinction can be made between direct and indirect methods, wherein the direct methods comprise pulsed time-of-flight measurement methods and the indirect methods comprise phase-correlation-based time-of-flight measurement methods. The high-precision optical speed measurement is in turn based on methods that use the measurement of the Doppler effect via self-mixing interferometry.

However, known sensors are not capable of simultaneously detecting the speed and the thickness of conveyed objects. To obtain both values, a plurality of modalities of the sensor therefore usually have to be combined. Furthermore, high-precision distance sensors require a complex assembly and manual orientation of the sensor to ensure that the sensor is oriented orthogonally to the conveying apparatus and thus the actual thickness of the conveyed object is measured.

It is therefore an object of the invention to specify an improved apparatus for monitoring a transport process, said apparatus enabling a more efficient, more accurate and more cost-effective monitoring and being easy to install.

The object is satisfied according to a first aspect of the invention by an apparatus having the features of claim 1 and in particular in that the apparatus has at least one optoelectronic sensor and a control and evaluation unit, wherein the sensor is configured to transmit transmission light in the form of at least one transmission light beam and to receive transmission light remitted or reflected by an object in the direction of the sensor as reception light, wherein the control and evaluation unit is configured to determine a radial distance d_{rad} and a radial speed v_{rad} of the object on the basis of the reception light, and wherein the control and evaluation unit is configured to determine the orthogonal distance dₒᵣₜₕ between the sensor and the object by means of the radial speed v_{rad} and the radial distance d_{rad} of the object.

The apparatus is in particular arranged in a stationary manner above the conveying apparatus. Transmission light, which is transmitted to the conveying apparatus in the form of at least one transmission light beam, is remitted or reflected by the conveying apparatus or objects conveyed by it and is received by the sensor as reception light. The control and evaluation unit analyzes the transmission light and the reception light and determines, form the obtained data, a radial distance d_{rad} and a radial speed v_{rad} of the reflecting or remitting object, i.e. the conveying apparatus or the conveyed object.

However, the radial distance d_{rad} generally does not correspond to the orthogonal distance dₒᵣₜₕ between the sensor and the reflecting or remitting object since an exact determination of this quantity requires an exact orthogonal orientation of the transmission light beam and the object. In particular, a direct determination of the orthogonal distance dₒᵣₜₕ of a conveyed object requires an orthogonal orientation of the transmission light beam and a transport plane of the conveying apparatus. In addition to a complex installation, the required orthogonal orientation, however, also has the disadvantage that a determination of the radial speed v_{rad}, which is, for example, required for a length measurement of the object, is no longer possible with this configuration of the sensor.

The control and evaluation unit is therefore configured to determine the orthogonal distance dₒᵣₜₕ of the object indirectly from the determined radial speed v_{rad} and the radial distance d_{rad} of the object. It is hereby made possible to simultaneously determine the radial speed v_{rad} and the orthogonal distance dₒᵣₜₕ of the object. Thus, precise values of the radial speed v_{rad} and the orthogonal distance dₒᵣₜₕ can be obtained by a single measurement, wherein a complex orientation of the sensor or the transmission light beam can be omitted.

The apparatus is thus easy to install and enables a more efficient, more accurate and more cost-effective monitoring of the transport process.

According to one embodiment, the transmission light beam forms a non-orthogonal angle α with respect to a conveying direction of the transport apparatus. The apparatus is thus configured to determine the distance of conveyed objects even at an angle from the object normal and to nevertheless calculate the orthogonal distance accurately. A time-consuming manual calibration of the orientation of the sensor or of the transmission light beam to establish the orthogonality as part of the assembly and the putting into operation is thus not necessary and can be omitted.

According to one embodiment, the control and evaluation unit is configured to simultaneously determine the radial speed v_{rad,obj} and the thickness D_{obj} of an object conveyed by the conveying apparatus on the basis of the reception light. The non-orthogonal orientation of the transmission light beam makes it possible, in addition to the radial distance d_{rad,obj}, to also determine the radial speed v_{rad,obj} of the conveyed object at the same time. The orthogonal distance d_{orth,obj} between the sensor and the object, which is determined from the radial speed v_{rad,obj} and the radial distance d_{rad,obj} of the conveyed object, furthermore makes it possible to simultaneously determine the thickness D_{obj} of the conveyed object, which is in particular useful in the context of the quality control.

According to one embodiment, the sensor is a Frequency-Modulated Continuous Wave (FMCW) LiDAR sensor, in particular a 1D FMCW LiDAR sensor. Unlike a LiDAR sensor based on a time-of-flight measurement of laser pulses, an FMCW LiDAR sensor does not transmit pulsed transmission light beams, but rather transmits continuous transmission light beams that have a predefined frequency modulation, i.e. a time variation of the wavelength of the transmission light, during a measurement. The measurement frequency is here typically in the range of several 10 kHz. The frequency modulation can, for example, be formed as a periodic upward and downward modulation. Transmission light reflected by the object has, compared to transmitted transmission light, a time offset corresponding to the time of light that depends on the distance of the object from the sensor and that is accompanied by a frequency shift due to the frequency modulation. Transmitted and reflected transmission light is coherently superposed in an FMCW LiDAR sensor, wherein the distance of the object from the sensor can be determined from the superposition signal. Compared to pulsed or amplitude-modulated incoherent LiDAR measurement principles, this coherent superposition inter alia has the advantage of an increased immunity with respect to extraneous light from, for example, other optical sensors or the sun. If an object moves towards the sensor or away from the sensor at a radial speed, the reflected transmission light additionally has a Doppler shift. The distance and the radial speed of a measurement point can be determined from this change in the transmission light frequency in a single measurement, whereas, in the case of a LiDAR sensor based on a time-of-flight measurement of laser pulses, at least two measurements of the same measurement point that are spaced apart in time are required for a determination of the radial speed, wherein such a calculation can usually be very error-prone due to the measurement noise. For moving objects whose radial distance from the sensor does not change, such a derivation of the radial speed cannot be performed at all. Depending on the configuration of the FCWM LiDAR sensors, they can acquire measurement data in one or more dimensions. A multidimensional design is not necessary for the present apparatus. The sensor can thus be configured as a 1D FCWM LiDAR sensor that, in addition to the radial distance from a point of incidence of the transmission light beam on the object, also determines the radial speed of said object.

According to one embodiment, the control and evaluation unit is configured to determine the orthogonal distance dₒᵣₜₕ of the object in accordance with

dₒᵣₜₕ=d_{rad}*sin(α)=d_{rad}*sin(arccos(v_{rad}/v))

from the radial distance d_{rad} of the object, the radial speed v_{rad} of the object and the conveying speed v of the conveying apparatus. This means that, by means of the measurement of the radial speed v_{rad}, the measurement of the radial distance d_{rad}, which takes place at an angle α with respect to a transport plane of the conveying apparatus, can be corrected and thus an orthogonal measure of the distance dₒᵣₜₕ from the object is obtained for a known conveying speed v of the conveying apparatus. In this respect, the fact is utilized that the radial speed v_{rad} represents the projection of the speed vector v of the object onto the direction vector of the transmission light beam, which can be expressed by cos(α)=v_{rad}/v. Since it simultaneously applies that the orthogonal distance dₒᵣₜₕ of the object results in accordance with dₒᵣₜₕ=d_{rad}*sin(α) from the determined radial distance d_{rad} and the angle α of the transmission light beam relative to the transport plane, the orthogonal distance dₒᵣₜₕ can be calculated in accordance with

$${d}_{orth} = {d}_{r a d} sin ( arc cos ( \frac{{v}_{r a d}}{v} ) ) .$$

According to one embodiment, the apparatus is configured, on the putting into operation of the conveying apparatus that is operated at a conveying speed v, in particular a settable conveying speed v, to perform a calibration measurement in which the orthogonal distance d_{orth,F} of the transport plane is determined by means of the determined radial distance d_{rad,F} and the determined radial speed v_{rad,F} of a transport plane of the conveying apparatus, wherein no objects are conveyed by the conveying apparatus during the calibration measurement. During the calibration measurement, i.e. the “teaching in” of the sensor, the conveying apparatus is accelerated to the conveying speed v desired for the transport operation and determines the radial speed v_{rad,F} by means of the apparatus. It is important here that there is no object on the conveying apparatus in order to avoid a falsification of the measurement by a possible slippage between the object and the conveying apparatus and to determine the actual reference distance between the sensor and the transport plane. The orthogonal distance d_{orth,F} between the sensor and the transport plane results from the values obtained in the calibration measurement in accordance with

$${d}_{orth , F} = {d}_{rad , F} sin ( arc cos ( \frac{{v}_{rad , F}}{v} ) ) .$$

The control and evaluation unit is in particular configured to repeat the calibration measurement during the normal operation after the putting into operation of the conveying apparatus, wherein no objects are conveyed by the conveying apparatus during the calibration measurement. The sensor can thus be recalibrated during ongoing operation. For this purpose, only the speed v of the conveying apparatus must be known to be able to calculate the factor v_{rad}/v. Due to the repeated calibration measurements, slight deviations from the original assembly position of the sensor that can occur during ongoing operation can also be compensated or identified. In a further development of this embodiment, the control and evaluation unit can be configured to determine, based on a distance measurement, whether objects are conveyed by the conveying apparatus and to start the calibration measurement if no object is detected.

According to one embodiment, the control and evaluation unit is configured to determine the radial distance d_{rad,obj} and the radial speed v_{rad,obj} of an object conveyed by the conveying apparatus at the conveying speed v, to determine the orthogonal distance d_{orth,obj} of the object from the determined values and to calculate the thickness D_{obj} of the object in accordance with D_{obj}=d_{orth,obj}−d_{orth,F}. The orthogonal distance d_{orth,obj} of the conveyed object results from the determined values of the radial distance d_{rad,obj} and the radial speed v_{rad,obj} of the conveyed object in accordance with

$${d}_{orth , obj} = {d}_{rad , obj} sin ( arc cos ( \frac{{v}_{rad , obj}}{v} ) ) .$$

Once the orthogonal distance of the sensor d_{orth,F} from a transport plane of the conveying apparatus is known through the calibration measurement, the thickness D_{obj} of the conveyed object can be calculated in accordance with D_{obj}=d_{orth,obj}−d_{orth,F}. Thus, by means of the apparatus, the thickness D_{obj} and the radial speed v_{rad,obj} of an object conveyed by the conveying apparatus can simultaneously be determined with great accuracy.

According to one embodiment, the control and evaluation unit is configured to determine the length L_{obj} of an object conveyed by the conveying apparatus at the conveying speed v by a temporal integration of the determined radial speed values v_{rad},obi of the object or of an object speed v_{obj} derived from the determined radial speed values v_{rad,obj} of the object. In general, v=v_{obj} applies in the case of a non-slip transport of the conveyed goods. With the aid of the radial speed v_{rad,obj}, the length L_{obj} of the already conveyed goods can thus be determined. This is relevant, for example, for film, paper and wood as conveyed goods since the waste can thereby be optimized, i.e. minimized.

According to one embodiment, the radial distances d_{rad} and radial speeds v_{rad} of the object each correspond to a combination of discrete determinations of the radial distance and radial speed that took place after one another in time. The combination of discrete determinations can, for example, involve the formation of a weighted or unweighted mean value or other suitable statistical variables. Due to such a combination of the determined measurement values, statistical errors in the speed and distance measurement can be corrected or minimized.

According to one embodiment, the control and evaluation unit is configured to orient the transmission light beam of the sensor orthogonally to a transport plane of the conveying apparatus in that the sensor is first oriented, in particular by pivoting, such that the determined radial speed v_{rad,F} of the conveying apparatus operated at the conveying speed v is minimized and the sensor is then oriented such that the radial speed v_{rad,F} remains minimal and the determined radial distance d_{rad,F} of the transport plane is minimized at the same time. The radial speed is zero if the speed vector of a reflecting or remitting object and the transmission light beam are perpendicular to one another. This condition can be used to orient the transmission light beam perpendicular to the transport plane. In this respect, the transmission light beam is oriented in a first step such that the radial speed measurement v_{rad} with respect to the transport plane is minimized. In a second step, the transmission light beam is now oriented such that the radial speed v_{rad} continues to remain minimal, but the radial distance measurement d_{rad} with respect to the transport plane is also minimized at the same time. If both conditions are met, the transmission light beam is optimally oriented orthogonally to the transport plane and the orthogonal distance d_{orth,obj} of a conveyed object can be determined directly and the thickness D_{obj} of the object can be determined precisely. However, a speed measurement of the object is no longer possible in this case.

According to one embodiment, the sensor is configured to transmit transmission light in the form of at least two transmission light beams, wherein the respective angles of the transmission light beams differ with respect to a conveying direction of the transport apparatus. The extension of the apparatus with additional transmission light beams in particular makes it possible to directly determine the orientation of the sensor in a plurality of planes of rotation. The sensor can preferably be oriented such that an axis extending substantially perpendicular to the transport plane lies in a plane spanned by the two transmission light beams. Then, the orthogonal distance d_{orth,F} of the transport plane from the sensor can be determined by simple geometric considerations since in this case the transmission light beams and the straight line between the points of incidence of the transmission light beams on the transport plane form a triangle, wherein a height of the triangle corresponds to the orthogonal distance d_{orth,F} of the transport plane from the sensor that can be calculated from the side lengths of the triangle.

According to a preferred variant of the aforementioned embodiment, the apparatus is configured to transmit transmission light in the form of two transmission light beams and, on the basis of the respective received reception light, to determine respective radial distances d1_{rad,F}, d2_{rad,F} and radial speeds v1_{rad,F}, v2_{rad,F} of a transport plane of the conveying apparatus operated at the conveying speed v and to orient the sensor by pivoting about an axis extending substantially perpendicular to the transport plane such that the radial speeds v1_{rad,F} and v2_{rad,F} are maximized and correspond to respective maximum values v1_{rad,F},max and v2_{rad,F},max, wherein the control and evaluation unit is configured to first calculate the Cartesian 3D coordinates of the points of incidence \vec{Pₕᵢₜ₁} and \vec{Pₕᵢₜ₂} of the two transmission light beams on the transport plane in the coordinate system of the sensor by multiplying the radial distances d1_{rad,F}, d2_{rad,F} by the unit vectors \vec{B₁} and \vec{B₂} of the transmission light beams, and then to calculate the Euclidean distance dHits of \vec{Pₕᵢₜ₁} and \vec{Pₕᵢₜ₂}, i.e. the distance between the two points of incidence, in accordance with

dHits(\vec{Pₕᵢₜ₁}−\vec{Pₕᵢₜ₂})², where

\vec{Pₕᵢₜ₂}=\vec{B₁}·d1_{rad,F}

\vec{Pₕᵢₜ₂}=\vec{B}₂·\vec{d}2_{rad,F},

wherein d1_{rad,F} and d2_{rad,F} correspond to the radial distances of the transport plane that are associated with the radial speeds v1_{rad,F},max and v2_{rad,F,max}. dHits, d1_{rad,F} and d2_{rad,F} form the edge lengths of a triangle whose height represents the orthogonal distance d_{orth,F} of the transport plane from the sensor that can be calculated directly. Accordingly, the control and evaluation unit is configured to calculate the orthogonal distance d_{orth,F} of the transport plane from the sensor in accordance with

$${d}_{orth , F} = \frac{2}{dHits} \cdot \sqrt{s \cdot ( s - d {1}_{rad , F} ) \cdot ( s - d {2}_{rad , F} ) \cdot ( s - dHits )} ,$$

$$where$$

$$s = 0.5 \cdot ( d {1}_{rad , F} + d {2}_{rad , F} + dHits ) .$$

The design with two transmission light beams in turn enables an iterative procedure, wherein the determined radial speeds v1_{rad,F} and v2_{rad,F} of the two transmission light beams are maximized by pivoting the sensor with respect to an axis extending substantially perpendicular to the transport plane. With this orientation step, the sensor can be oriented such that the plane spanned by the transmission light beams is arranged parallel to the conveying direction. An additional step for subsequently minimizing the determined values of the radial distance d1_{rad} and d2_{rad} is no longer necessary since the orthogonal distance d_{orth,F} of the transport plane can be calculated directly by the two distance measurements d1_{rad,F} and d2_{rad,F} that now took place parallel to the conveying direction.

As an alternative to the last-named embodiment, the apparatus is configured to transmit transmission light in the form of two transmission light beams and, on the basis of the respective received reception light, to determine respective radial distances d1_{rad,F}, d2_{rad,F} and radial speeds v1_{rad,F}, v2_{rad,F} of a transport plane of the conveying apparatus operated at the conveying speed v and to orient the sensor by pivoting about an axis extending substantially perpendicular to the transport plane such that the radial speeds v1_{rad,F} and v2_{rad,F} are minimized and correspond to respective maximum values v1_{rad,F,min} and v2_{rad,F,min}, wherein the control and evaluation unit is configured to first calculate the Cartesian 3D coordinates of the points of incidence \vec{Pₕᵢₜ₂} and \vec{Pₕᵢₜ₂} of the two transmission light beams on the conveyor belt in the coordinate system of the sensor by multiplying the radial distances d1_{rad,F}, d2_{rad,F} by the unit vectors \vec{B₁} and \vec{B₂} of the transmission light beams, and then to calculate the Euclidean distance dHits of \vec{Pₕᵢₜ₂} and \vec{Pₕᵢₜ₂}, i.e. the distance between the two points of incidence, in accordance with

dHits(\vec{Pₕᵢₜ₁}−\vec{Pₕᵢₜ₂})², where

\vec{Pₕᵢₜ₂}=\vec{B₁}·d1_{rad,F}

\vec{Pₕᵢₜ₂}=\vec{B}₂·\vec{d}2_{rad,F},

wherein d1_{rad,F} and d2_{rad,F} correspond to the radial distances of the transport plane that are associated with the radial speeds v1_{rad,F,min} and v2_{rad,F,min}. dHits, d1_{rad,F} and d2_{rad,F} form the edge lengths of a triangle whose height represents the orthogonal distance d_{orth,F} of the transport plane from the sensor that can be calculated directly. Accordingly, the control and evaluation unit is configured to calculate the orthogonal distance d_{orth,F} of the transport plane from the sensor in accordance with

$${d}_{orth , F} = \frac{2}{dHits} \cdot \sqrt{s \cdot ( s - d {1}_{rad , F} ) \cdot ( s - d {2}_{rad , F} ) \cdot ( s - dHits )} ,$$

$$where$$

$$s = 0.5 \cdot ( d {1}_{rad , F} + d {2}_{rad , F} + dHits ) .$$

The design with two transmission light beams in turn enables an iterative procedure, wherein the determined radial speeds v1_{rad,F} and v2_{rad,F} of the two transmission light beams are minimized by pivoting the sensor with respect to an axis extending substantially perpendicular to the transport plane. With this orientation step, the sensor can be oriented such that the plane spanned by the transmission light beams is arranged perpendicular to the conveying direction. An additional step for the subsequent minimization of the determined values of the radial distance d1_{rad} and d2_{rad} is no longer necessary since the orthogonal distance d_{orth,F} of the transport plane can be calculated directly by the two distance measurements d1_{rad,F} and d2_{rad,F} that now took place perpendicular to the conveying direction.

According to one embodiment, the apparatus is configured to transmit transmission light in the form of three transmission light beams and, on the basis of the respective received reception light, to determine radial distances d_{rad,F} and radial speeds v_{rad,F} of a transport plane of the conveying apparatus, wherein the control and evaluation unit is configured to calculate the orientation of the transport plane in a three-dimensional space and/or the normal vector of said transport plane from the three determined radial distances d_{rad,F} of the transport plane. The spatial coordinates of the three points of incidence of the transmission light beams on the transport plane can be determined from the determined respective radial distances of the transport plane, whereby the spatial arrangement of the transport plane is defined relative to the sensor and the transmission light beams.

According to one embodiment, the control and evaluation unit is configured to calculate the orthogonal distance d_{orth,F} of the sensor from the transport plane and the thickness D_{obj} of a conveyed object solely from the determined radial distances of the sensor from the transport plane and from the conveyed object. A design of the sensor with three transmission light beams makes it possible to directly determine the spatial arrangement of the transport plane and its normal vector and thus to calculate the distance of the sensor from the transport plane. In this case, a measurement of the radial speed of a conveyed object is not necessary for the determination of the orthogonal distance d_{orth,obj} and the thickness D_{obj}.

According to a second aspect of the invention, the object is furthermore satisfied by a method for monitoring a transport process by means of a conveying apparatus, in particular a conveyor belt, by an apparatus, wherein the apparatus has at least one optoelectronic sensor and a control and evaluation unit, wherein the sensor transmits transmission light in the form of at least one transmission light beam and receives transmission light remitted or reflected by an object in the direction of the sensor as reception light, the control and evaluation unit determines a radial distance d_{rad} and a radial speed v_{rad} of the object on the basis of the reception light, and wherein the control and evaluation unit determines the orthogonal distance dₒᵣₜₕ between the sensor and the object by means of the radial speed v_{rad} and the radial distance d_{rad} of the object.

The method according to the invention can be carried out by means of the apparatus according to the invention or one of its embodiments. The statements regarding the apparatus and the embodiments apply accordingly.

The invention will be explained only by way of example in the following with reference to the Figures.

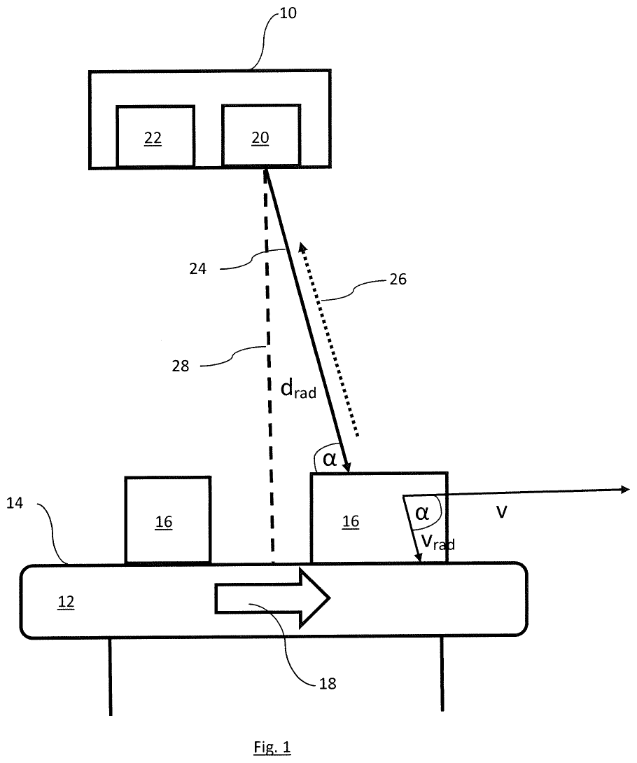

FIG. 1 shows an embodiment of an apparatus according to the invention for monitoring a transport process in a schematic representation,

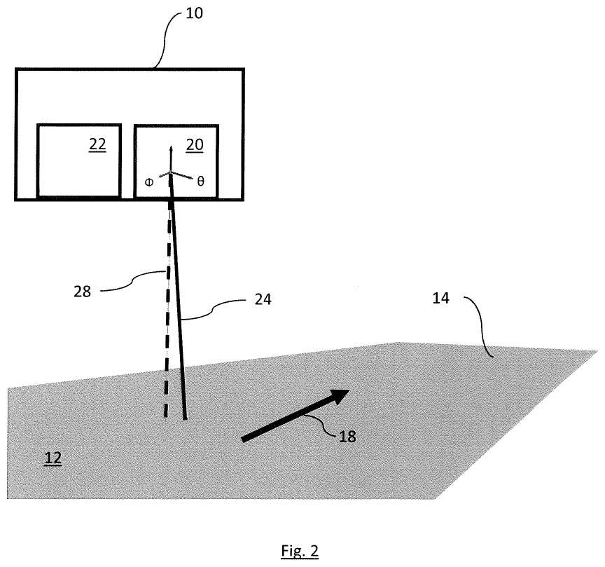

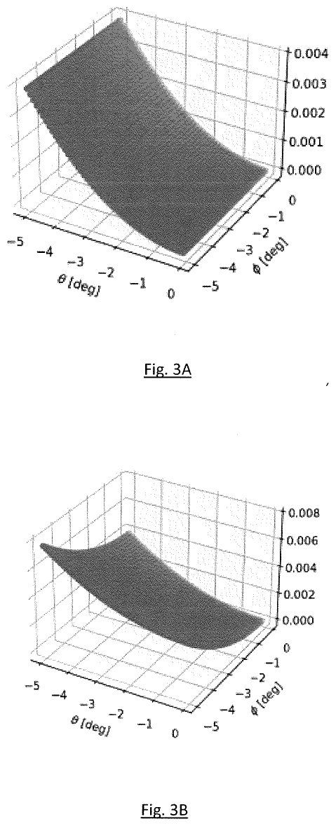

FIG. 2 shows a schematic visualization of a 3D simulation for determining the accuracy of the orthogonal distance measurement by means of the embodiment of FIG. 1;

FIGS. 3A and 3B show analysis diagrams of the results of the simulation of FIG. 2;

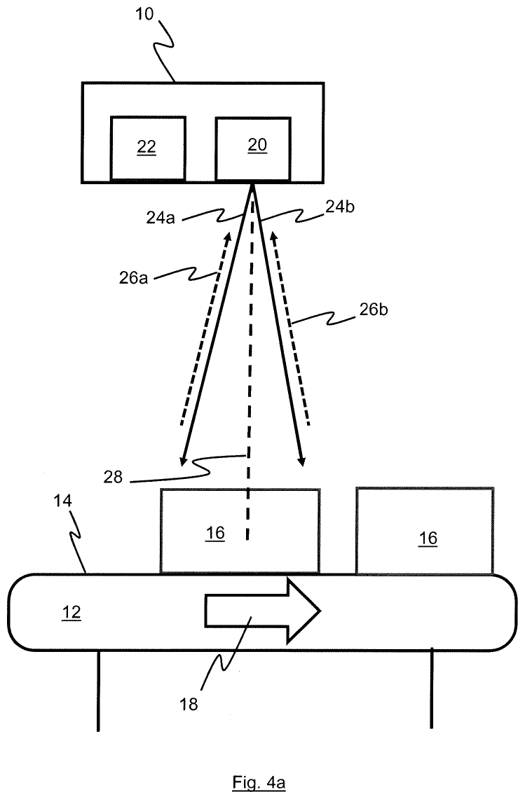

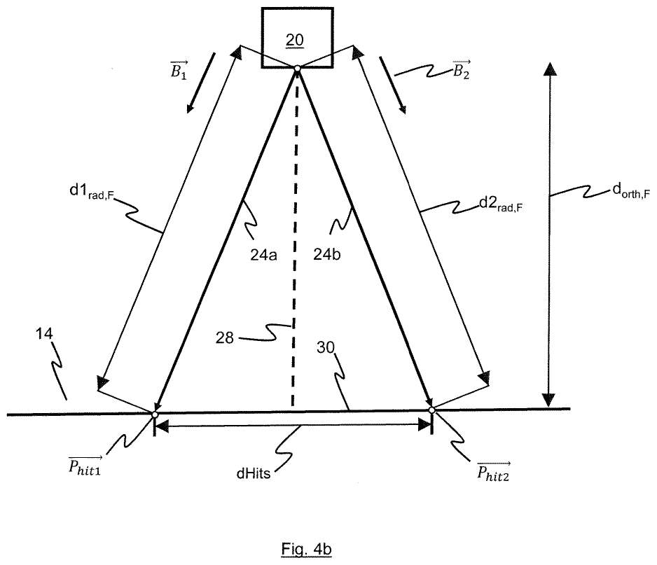

FIG. 4a shows an embodiment of an apparatus according to the invention with two transmission light beams; and

FIG. 4b shows an example of the calculation of the orthogonal distance between the sensor and the transport plane in one embodiment of an apparatus according to the invention with two transmission light beams;

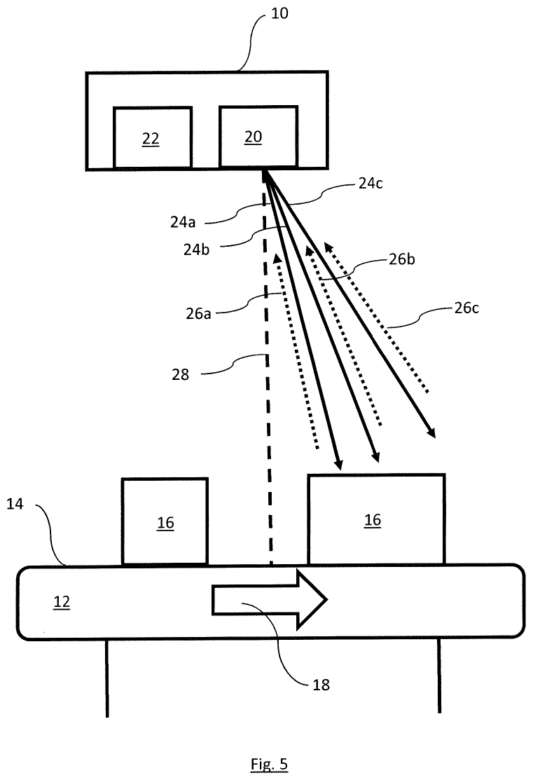

FIG. 5 shows an embodiment of an apparatus according to the invention with three transmission light beams.

FIG. 1 shows an embodiment of an apparatus 10 according to the invention for monitoring a transport process in a schematic representation. The apparatus is arranged in a stationary manner above a conveyor belt 12 on which a plurality of objects 16, for example goods or packages, are moved in the conveying direction 18.

The apparatus 10 has an optoelectronic sensor 20 and a control and evaluation unit 22. The sensor is a 1 D Frequency-Modulated Continuous Wave (FMCW) LiDAR sensor and is configured to transmit transmission light 24 in the form of a transmission light beam directed to the conveyor belt 12 and to receive transmission light remitted or reflected by a conveyed object 16 or the conveyor belt 12 in the direction of the sensor 20 as reception light 26. In this respect, the transmission light is transmitted such that the transmission light beam 24 forms an angle α with respect to the conveying direction 18 of the conveyor belt 12 that forms a transport plane 14 of the conveying apparatus. The conveying direction 18 of the conveyor belt 12 is illustrated by an arrow in FIG. 1. The control and evaluation unit 22 is configured to determine a radial distance d_{rad} and a radial speed v_{rad} of the objects 16 on the basis of the reception light 26 as soon as the objects pass the transmission light beam 24 of the sensor 20 on the conveyor belt 12.

The control and evaluation unit 22 is furthermore configured to determine the orthogonal distance d_{orth,obj} of the objects 16 in accordance with

d_{orth,obj}=d_{rad,obj}*sin(α)=d_{rad,obj}*sin(arccos(v_{rad,obj}/v))

from the determined radial distance d_{rad,obj} of the objects 16, the determined radial speed v_{rad,obj} of the objects 16 and the known conveying speed v of the conveyor belt 12.

From the determined values of the radial distance d_{rad,obj} and the radial speed v_{rad,obj} of the objects 16, the control and evaluation unit 22 determines the orthogonal distance d_{orth,obj} and the thickness D_{obj} of the objects in accordance with D_{obj}=d_{orth,obj}−d_{orth,F}, where d_{orth,F} corresponds to the orthogonal distance between the sensor 20 and the transport plane 14. Thus, by means of the apparatus 10, the thickness D_{obj} and the radial speed v_{rad,obj} of the conveyed objects 16 can be simultaneously determined with great accuracy. The length L_{obj} of the conveyed objects 16 can furthermore be determined by a temporal integration of the radial speed v_{rad,ob} or of an object speed v_{obj} derived from the determined radial speed values v_{rad,obj} of the object 16. This is relevant, for example, for film, paper and wood as conveyed goods since the waste can thereby be optimized, i.e. minimized.

The radial distances d_{rad,obj} and radial speeds v_{rad,obj} of the objects 16 can in this respect each correspond to a combination of discrete determinations of the radial distance and radial speed that took place after one another in time. The combination of the discrete determinations can, for example, involve the formation of weighted or unweighted mean values or other suitable statistical variables. Due to the temporal integration of the determined measurement values, statistical errors in the speed and distance measurement can be corrected or minimized to further increase the accuracy of the measurements.

The orthogonal distance d_{orth,F} between the sensor 20 and the transport plane 14 can, for example, be determined by a calibration measurement when putting the apparatus 10 into operation. During such a “teaching in” of the sensor 20, the conveyor belt 12 is accelerated to the conveying speed v desired for the conveying operation and the radial speed v_{rad,F} of the conveyor belt 12 is determined by means of the apparatus 10. It is important here that there is no object on the conveyor belt 12 in order to avoid a falsification of the measurement by a possible slippage between the object and the conveyor belt 12 and to determine the actual reference distance between the sensor 20 and the transport plane 14. In particular, the calibration measurement can be repeated during the normal operation after the putting into operation of the conveying apparatus 12, wherein the conveyor belt 12 is again kept free of objects during the calibration measurement. The sensor 20 can thus be easily recalibrated to compensate for slight deviations from the original assembly position of the sensor 20 that can occur during ongoing operation.

The accuracy of the determinations of the orthogonal distance d_{orth,F} of a transport plane 14 of a conveyor belt 12 that can be achieved by the apparatus 10 was validated with the aid of a 3D simulation. A visualization of this 3D simulation is shown by way of example in FIG. 2, wherein the gray area describes the transport plane 14 and the coordinate system represents the position of the sensor 20 above the transport plane 14. The conveying direction 18 of the conveyor belt 12 is shown by an arrow in FIG. 2. The sensor 20 transmits a transmission light beam 24 that is shown by a solid line and that is not transmitted along the perpendicular 28, which is shown by a dashed line, from the sensor 20 to the transport plane 14. With the aid of this simulation, the accuracy of the distance measurement was now investigated for different orientations of the sensor. For this purpose, the sensor 20 and the transmission light beam 24 were rotated by an angle θ about an axis that is perpendicular to the conveying direction 18 in the transport plane 14 or by an angle Φ about an axis parallel to the conveying direction 18. For the respective values of the rotation angles θ and Φ of the sensor 20 and the transmission light beam 24, the radial distance d_{rad} and the radial speed v_{rad} of the transport plane 14 were determined and the distance measurement was corrected to obtain the value of the orthogonal distance dₒᵣₜₕ.

FIG. 3A shows, as a result of the simulation of FIG. 2, the error in meters of the determined orthogonal distance of the transport plane 14 of the conveyor belt 12 for rotations of the transmission light beam 24 by different values of θ and Φ. As can be seen in FIG. 3A, for θ=0°, the error after the correction corresponds to 0 m. This means that the distance measurement can be optimally corrected with this arrangement of the sensor 20 and the transmission light beam 24. However, if the transmission light beam 24 is also tilted by the angle θ, the error in this example increases to a maximum of 0.004 m, wherein Φ was tilted to a maximum of 5°. Larger tilts or swivels of the sensor 20 and the transmission light beam 24 should be mechanically corrected by a visible congruent marking laser in the 1D FMCW LiDAR.

FIG. 3B shows, for a comparison, the error values for a distance sensor according to the prior art that is not configured to perform a correction of the distance measurement in order to determine the orthogonal distance. Without the correction according to the invention of the radial distance values, the error increases directly with a rotation about θ and with a rotation about Φ and reaches a maximum value of 0.008 m.

The apparatus 10 is thus configured to determine the distance of conveyed objects 16 even at a non-orthogonal angle to the object normal and to nevertheless determine the orthogonal distance dₒᵣₜₕ with a high accuracy. A time-consuming manual calibration of the orientation of the sensor 20 and the transmission light beam 24 to establish the orthogonality as part of the assembly and the putting into operation is thus not necessary and can be omitted. The apparatus 10 thus enables an efficient, accurate and cost-effective monitoring and is furthermore easy to install.

If a determination of the radial speed and the length of the conveyed object 16 is not necessary for the monitoring of the transport process, the transmission light beam 24 can be oriented perpendicular to the transport plane 14 by means of a simple process, in particular by a pivoting of the sensor 20, to precisely determine the orthogonal distance d_{orth,obj} of the conveyed object 16 and its thickness D_{obj} in a direct manner. In this respect, the transmission light beam 24 is oriented in a first step such that the radial speed measurement v_{rad} with respect to the transport plane 14 is minimized. In a second step, the transmission light beam 24 is now oriented such that the radial speed v_{rad} continues to remain minimal, but the radial distance measurement d_{rad} with respect to the transport plane 14 is also minimized at the same time. If both conditions are met, the transmission light beam 24 is optimally oriented orthogonally to the transport plane 14 and the orthogonal distance d_{orth,obj} of a conveyed object 16 can be determined directly.

FIG. 4a shows a further embodiment of the apparatus 10 according to the invention that differs from the embodiment of FIG. 1 in that the sensor 20 transmits two transmission light beams 24a, 24b, wherein the respective angles of the transmission light beams 24a, 24b differ with respect to a conveying direction 18 of the transport apparatus 12. In an embodiment with two transmission light beams 24a, 24b, it is again possible to proceed iteratively in order to maximize or minimize the determined radial speeds v1_{rad,F} and v2_{rad,F} of the two transmission light beams 24a, 24b by orienting the sensor 20. A further step for subsequently minimizing the determined values of the radial distance d1_{rad} and d2_{rad} is no longer necessary since, as described above, the orthogonal distance d_{orth,F} of the transport plane 14 can be calculated by the two available distance measurements d1_{rad,F} and d2_{rad,F}.

This is illustrated in FIG. 4b. If the determined radial speeds v1_{rad,F} and v2_{rad,F} of the two transmission light beams 24a, 24b are maximized or minimized, the axis 28 extending substantially perpendicular to the transport plane 14 lies in a plane spanned by the two transmission light beams 24a, 24b, in this example the drawing plane. The transmission light beams 24a, 24b and the straight line 30 between the points of incidence \vec{Pₕᵢₜ₁}, \vec{Pₕᵢₜ₂} of the transmission light beams 24a, 24b on the transport plane 14 form a triangle, wherein a height of the triangle corresponds to the orthogonal distance d_{orth,F} of the sensor 20 from the transport plane 14. The points of incidence \vec{Pₕᵢₜ₁} and \vec{Pₕᵢₜ₂} of the two transmission light beams 24a, 24b on the transport plane 14 can be determined in the coordinate system of the sensor 20 by multiplying the radial distances d1_{rad,F}, d2_{rad,F} by the unit vectors \vec{B₁} and \vec{B₂} of the transmission light beams 24a, 24b. The Euclidean distance dHits, i.e. the length of the straight line 30 between the points of incidence \vec{Pₕᵢₜ₁} and \vec{Pₕᵢₜ₂}, can then be calculated. The height of the triangle, i.e. the orthogonal distance d_{orth,F} of the sensor 20 from the transport plane 14, then, as described above, results from:

$${d}_{orth , F} = \frac{2}{dHits} \cdot \sqrt{s \cdot ( s - d {1}_{rad , F} ) \cdot ( s - d {2}_{rad , F} ) \cdot ( s - dHits )} ,$$

$$where$$

$$s = 0.5 \cdot ( d {1}_{rad , F} + d {2}_{rad , F} + dHits ) .$$

FIG. 5 shows a further embodiment of the apparatus 10 according to the invention that differs from the embodiment of FIG. 1 in that the sensor 20 transmits three transmission light beams 24a, 24b, 24c, wherein the respective angles of the transmission light beams 24a, 24b, 24c differ with respect to a conveying direction 18 of the transport apparatus 12. A design of the sensor 20 with three transmission light beams 24a, 24b, 24c makes it possible to directly calculate the orientation of the transport plane 14 and its normal vector and thus to determine the distance of the sensor 20 from the transport plane 14. In this case, a measurement of the radial speed v_{rad,obj} of a conveyed object 16 is not necessary for the determination of the orthogonal distance d_{orth,obj} and the thickness D_{obj}.

### REFERENCE NUMERALS

10 apparatus for monitoring a transport process
12 conveyor belt
14 transport plane
16 object
18 conveying direction
optoelectronic sensor
22 control and evaluation unit
24 transmission light
24a transmission light
24b transmission light
24c transmission light
26 reception light
26a reception light
26b reception light
26c reception light
28 perpendicular from the sensor to the transport plane straight line
α angle of the transmission light beam to the orthogonal of the conveyor belt
θ pivot angle
Φ pivot angle

1. An apparatus for monitoring a transport process by means of a conveying apparatus,
wherein the apparatus has at least one optoelectronic sensor and a control and evaluation unit,
wherein the sensor is configured to transmit transmission light in the form of at least one transmission light beam and to receive transmission light remitted or reflected by an object in the direction of the sensor as reception light,
wherein the control and evaluation unit is configured to determine a radial distance d_{rad} and a radial speed v_{rad} of the object on the basis of the reception light, and wherein the control and evaluation unit is configured to determine the orthogonal distance dₒᵣₜₕ between the sensor and the object by means of the radial speed v_{rad} and the radial distance d_{rad} of the object.

2. The apparatus according to claim 1, wherein the transmission light beam forms a non-orthogonal angle α with respect to a conveying direction of the conveying apparatus.

3. The apparatus according to claim 1, wherein the control and evaluation unit is configured to simultaneously determine the radial speed v_{rad,obj} and the thickness D_{obj} of an object conveyed by the conveying apparatus on the basis of the reception light.

4. An apparatus according to claim 1, wherein the sensor is a Frequency-Modulated Continuous Wave, FMCW, LiDAR sensor.

5. The apparatus according to claim 2, wherein the control and evaluation unit is configured to determine the orthogonal distance dₒᵣₜh of the object in accordance with
dₒᵣₜₕ=d_{rad}*sin(α)=d_{rad}*sin(arccos(v_{rad}/v))
from the radial distance d_{rad} of the object, the radial speed vᵣₐd of the object and the conveying speed v of the conveying apparatus.

6. The apparatus according to claim 5, wherein the apparatus is configured, on the putting into operation of the conveying apparatus that is operated at a conveying speed v to perform a calibration measurement in which the orthogonal distance d_{orth,F} of the transport plane is determined by means of the determined radial distance d_{rad,F} and the determined radial speed v_{rad,F} of a transport plane of the conveying apparatus, wherein no objects are conveyed by the conveying apparatus during the calibration measurement, wherein no objects are conveyed by the conveying apparatus during the calibration measurement.

7. The apparatus according to claim 6, wherein the control and evaluation unit is configured to determine the radial distance d_{rad,obj} and the radial speed v_{rad,obj} of an object conveyed by the conveying apparatus at the conveying speed v, to determine the orthogonal distance d_{orth,obj} of the object from the determined values and to calculate the thickness D_{obj} of the object in accordance with D_{obj}=d_{orth,obj}−d_{orth,F}.

8. The apparatus according to claim 1, wherein the control and evaluation unit is configured to determine the length L_{obj} of an object conveyed by the conveying apparatus at the conveying speed v by a temporal integration of the determined radial speed values v_{rad,obj} or of an object speed v_{obj} of the object derived from the determined radial speed values v_{rad,obj} of the object.

9. The apparatus according to claim 1, wherein the radial distances and radial speeds each correspond to a combination of discrete determinations of the radial distance and radial speed that took place after one another in time.

10. The apparatus according to claim 1, wherein the control and evaluation unit is configured to orient the transmission light beam of the sensor orthogonally to a transport plane of the conveying apparatus operated at the conveying speed v in that the sensor is first oriented, such that the determined radial speed v_{rad,F} of the transport plane is minimized and the sensor is then oriented such that the radial speed v_{rad,F} remains minimal and the determined radial distance d_{rad,F} of the transport plane is minimized at the same time.

11. The apparatus according to claim 1, wherein the sensor is configured to transmit transmission light in the form of at least two transmission light beams, wherein the respective angles of the transmission light beams differ with respect to a conveying direction of the transport apparatus.

12. The apparatus according to claim 11, wherein the apparatus is configured to transmit transmission light in the form of two transmission light beams and, on the basis of the respective received reception light, to determine respective radial distances d1_{rad,F}, d2_{rad,F} and radial speeds v1_{rad,F}, v2_{rad,F} of a transport plane of the conveying apparatus operated at the conveying speed v and to orient the sensor by pivoting about an axis extending substantially perpendicular to the transport plane such that the radial speeds d1_{rad,F} and d2_{rad,F} are maximized or minimized and correspond to respective maximum values v1_{rad,F,max} and v2_{rad,F},max or minimum values v1_{rad,F,min} and v2_{rad,F,min}, wherein the control and evaluation unit is configured to calculate the orthogonal distance d_{orth,F} from the transport plane using the radial distances d1_{rad,F} and d2_{rad,F} from the transport plane that are associated with the radial speeds v1_{rad,F,min} and v2_{rad,F,min} or v1_{rad,F,min} and v2_{rad,F,min}.

13. The apparatus according to claim 11, wherein the apparatus is configured to transmit transmission light in the form of three transmission light beams and, on the basis of the respective transmitted transmission light beam and received reception light, to determine radial distances d_{rad,F} and radial speeds v_{rad,F} of a transport plane of the conveying apparatus, wherein the control and evaluation unit is configured to calculate the orientation of the transport plane in a three-dimensional space and/or the normal vector of said transport plane from the three determined radial distances d_{rad,F} of the transport plane.

14. The apparatus according to claim 13, wherein the control and evaluation unit is configured to calculate the orthogonal distance d_{orth,F} of the sensor from the transport plane and the thickness D_{obj} of a conveyed object solely from the determined radial distances of the sensor from the transport plane and from the conveyed object (16).

15. A method for monitoring a transport process by means of a conveying apparatus, by an apparatus, wherein the apparatus has at least one optoelectronic sensor and a control and evaluation unit, wherein the sensor transmits transmission light in the form of at least one transmission light beam and receives transmission light remitted or reflected by an object in the direction of the sensor as reception light, the control and evaluation unit determines a radial distance d_{rad} and a radial speed v_{rad} of the object on the basis of the reception light, and wherein the control and evaluation unit determines the orthogonal distance dₒᵣₜₕ between the sensor and the object by means of the radial speed v_{rad} and the radial distance d_{rad} of the object.

16. The apparatus according to claim 1, wherein the conveying apparatus is a conveyor belt.

17. The apparatus according to claim 4, wherein the LiDAR sensor is a 1D FMCW LiDAR sensor.

18. The apparatus according to claim 6, wherein the conveying speed v is a settable conveying speed v.

19. The apparatus according to claim 6, wherein the control and evaluation unit is configured to repeat the calibration measurement during the normal operation after the putting into operation of the conveying apparatus

20. The apparatus according to claim 10, wherein the first oriented sensor is moved by pivoting.
